(19) United States
(12) Patent Application Publication
(10) Pub. No.: US 2007/0294115 A1
(43) Pub. Date: Dec. 20, 2007

(54) Method for distributing insurance policy dividends

(76) Inventors: Marvin P. Loeb, Laguna Woods, CA (US); Edward D. Spriegel, Gurnee, IL (US)

Correspondence Address: OLSON & HIERL, LTD., 20 NORTH WACKER DRIVE, 36TH FLOOR, CHICAGO, IL, 60606, US

(21) Appl. No.: 11/724,472

(22) Filed: Mar. 15, 2007

Related U.S. Application Data
(60) Provisional application No. 60/783,334, filed on Mar. 17, 2006.

(51) Int. Cl. G06Q 40/00

(52) U.S. Cl. 705/4

(57) ABSTRACT

A method for distributing dividend monies from an insurance policy, such as a life insurance policy, to a policyholder. The method including the determination of an internal value for the insurance company's shares or other securities, offering the insurance company's shares or other securities to the policyholder at the internal value, and paying the dividend value in the form of the insurance company's or other securities at the internal value.

### CROSS-REFERENCE TO RELATED APPLICATION

This application claims the benefit of U.S. Provisional Patent Application No. 60/783,334 filed on Mar. 17, 2006, incorporated herein by reference.

### FIELD OF THE INVENTION

The present invention relates to the distribution of dividends paid on insurance policies, and more particularly to a method for distributing dividends from a life insurance policy in the form of securities of the insurance company.

### BACKGROUND OF THE INVENTION

Life insurance policies are commonly issued by insurance companies to policyholders under a variety of scenarios. Life insurance policies on which dividends are paid, which are commonly referred to as “participating” policies, offer the policyholder a variety of traditional dividend options. For example, the dividend can be paid in cash to the policyholder, left in an account with the company to earn interest, used to purchase extended term insurance, used to purchase additional paid-up insurance, or applied to the payment of premiums and other options.

One advantage of dividends on life insurance policies is that they are generally not subject to state or federal income taxes because they are regarded as a return of premium to the policy holder. Similarly, the proceeds of a life insurance policy, upon the death of the insured, are generally free of state and federal income and estate taxes, subject to certain limitations. However, if a policyholder leaves monies received by a dividend in an account with the insurance company, interest earned on dividends is generally taxable as ordinary income.

Essentially, dividends are excess monies paid in the form of premiums. In other words, premiums are paid by policyholders based on an estimate by the insurance company on the “future cost” of a policy. This future cost may include expenses related to billing for and collecting premiums, administration, investment costs, and death benefits based on mortality tables, less the expected return on the invested premiums. Many insurance companies illustrate the “net cost” to policy holders of life insurance by deducting from the premiums paid over, for example, a period of ten, twenty or more years, the historical level of dividends paid in prior years.

In many instances, insurance companies set their premiums at an amount equal to (a) the expected future cost of the policy, (b) the anticipated dividends to be paid out, and (c) a profit factor. The insurance commissions of the states, and similar authorities in foreign countries in which an insurance company is domiciled or incorporated, usually require that life insurance companies maintain part of the invested premiums against anticipated policyholder benefits as “reserves” and have at all times adequate levels of capital and reserves in proportion to the amount of life insurance sold. In many large life insurance companies, particularly mutual life insurance companies, annual profits are about equal to the amount of dividends paid to policyholders annually. As a result, among the larger insurance companies, participating policies are often offered at comparable premiums, dividend levels and projected net costs.

If, however, for a particular individual the premium for an insurance policy from one company is roughly the same as the premium for an insurance policy from another company, and the dividend in prior years of one company was historically larger, that company's net cost for the policy would be more attractive to prospective life insurance buyers than that of other companies. Accordingly, since the prospect of higher dividends exists with one company's policy over the other, this may result in more policies being purchased from the company with higher dividends and lower net cost.

While participating life insurance policies provide insurance against the event of death and are a regimented savings program, they are not, however, considered to be a good investment. This is mainly because the cost of commissions to brokers and agents is significantly higher than that of other investment vehicles, such as real estate, stocks, and bonds. For example, the commission on a participating life insurance policy can vary from about 55% to 100% or more of the first year's premium, and commissions on renewals of the policy may also account for a significant percentage of the premiums paid during the premium-paying life of the policy, usually 5% to 10% of the first ten years' premiums. Consequently, a life insurance product that provides a lower net cost and entails less selling expense may be regarded as a better investment, and increase its appeal to the public.

By increasing the appeal of a life insurance policy to the public, greater numbers of insurance policies may be sold by a particular insurance company, which result in greater revenues. In addition, efficiencies may be obtained through greater numbers of policies, such as a lower level of administrative and investment costs and commissions.

A few life insurance companies offer Dividend Reinvestment Plans, sometimes referred to as “DRIPS”, under which a policyholder may take the dividend in shares of the insurance company at the market price on the anniversary date of the policy or some earlier date, e.g., the first day of the month, the last day of the prior calendar quarter, or the date the policyholder's dividend application form is postmarked or received. Alternatively, the policyholder may take the dividend at a small discount to the market price of the shares at such a date, usually 1% to 10%. Since the market price of a company's shares is subject to fluctuation based on a variety of influences, however, market prices do not necessarily reflect the intrinsic value and future earning power of the life insurance company's shares. For example, events such as a merger of one life insurance company into another, the acquisition of a promising non-life insurance business, the acquisition of a business that starts losing money, or unanticipated costs of the transaction, may affect the market value of the life insurance company's shares to a lesser or greater extent than the intrinsic book value of the shares resulting from the merger or acquisition.

Policyholders applying dividends in DRIPS that offer registered (marketable) shares at a small discount from the market price frequently sell the shares to capture the discount, depressing the market value of the shares, as they know the market value can decline and erode or wipe-out gains from the discount thereby further affecting the market value despite there being no direct change to the intrinsic value of the company.

No income tax is customarily due on the dollar amount of the dividend. However, income tax may be due on either the discount from fair market value of the shares in the case of DRIPS or the difference between the fair market value of the shares and the internal value of the shares under the invention described herein, generally on the effective date of the transaction in both cases.

The present invention offers an alternative to any of the aforementioned investment methods. As will be discussed in detail below, the present invention provides an investment approach that is not subject to market price fluctuations, and relates more directly to the intrinsic value of the insurance company.

### SUMMARY OF THE INVENTION

The present invention relates to a method for returning or paying out dividends from an insurance policy by an insurance company to a policyholder in a manner designed to increase the attractiveness of the policy to prospective buyers. The method comprises determining an internal value for a share price or other security of the insurance company, offering the policyholder the option of taking the dividend on a policy in cash, or applying the same amount to the aforementioned traditional dividend applications, or taking the taking the dividend in the form of company shares or other securities at the internal value.

One example of a value that can be used as the internal value is the book value per share of the insurance company. This can be determined in accordance with generally accepted accounting principles, consistently applied, commonly referred to as GAAP book value. Alternatively, the price may be otherwise determined by the insurance company, and may be set periodically, e.g., monthly, quarterly, annually or on some other date.

In a preferred embodiment, the GAAP book value is utilized because takes into account the future profit to the insurance company of the volume of life insurance issued and outstanding, assuming an actuarially determined amount of claims which are expected to be paid, policy lapses, such as due to non-payment of the premium, and amortization of commissions payable to the life insurance agents and brokers. As a result, the internal GAAP book value of a share of common stock, for example, of a life insurance company is often a better indicator of the company's worth than applying a multiple of earnings to the current quarterly or annual net profit per share, which may reflect investment gains and other temporal effects on earnings, per share. The internal value of a share or other security of a life insurance company can be obtained from within the insurance company through its own published figure, from an agent of the company, from a third party, or the like. For example, certain financial information of a publicly traded company must be periodically reported to the SEC and may be obtained from the SEC Edgar database.

The common stock or other equity securities of publicly-traded life insurance companies often trade at a market price above a GAAP book value because the market takes into account the intrinsic GAAP book value of the company and its earnings per share and its demonstrated ability to continue to sell insurance policies, which will increase its book value in succeeding years. For example, if the GAAP book value of a publicly-traded life insurance company is $10 per share, the market price of its shares might be $15. If a policyholder was entitled to a $100 annual dividend and exercised the option to take 10 shares at a price of $10 each, the policy holder would have shares with a market value of $150. In order for the shares to be attractive to a policyholder, they should be marketable (saleable) by the policyholder. Typically, this requires that the shares or other security be registered with the appropriate authority. For example, in the United States, securities must be registered with the United States Securities and Exchange Commission (SEC) and with the state in which the insurance company is domiciled. Other securities regulations may require other registration requirements. The marketability of the shares obtained in this manner may also be subject to certain restrictions, such as a lock-in period. To be marketable in other countries, the laws regarding the marketability of saleability of securities will vary from country to country and by province, state or other jurisdiction thereof.

The effect of the sale of a life insurance policy in which the holder has applied the dividend to buy shares of the insurance company is that instead of paying out the dividend in cash, the shares are delivered to the holder at the per share GAAP book value. As a result, the life insurance company has, using the example given above, $100 more of funds to invest. The dividends earned on the $100 also increase the insurance company's future net profit per share and increase its book value in subsequent years. Consequently, a proportionate increase may occur in the market price of the shares reflecting the increased book value and net profit per share of the insurance company. Such an outcome may also enable an insurance company to meet or exceed certain capital and cash reserve regulations, such as a state insurance commission's “capital-to-premium” ratio.

The policies of the insurance company also become more attractive to policyholders than those of competitors not offering such an option, enabling it to increase sales. Also, since the company's policies are more attractive to prospective policyholders, the insurance company may experience added economies of scale with its administrative, investment and sales costs, further increasing its profits and, hence, increasing its profit per share, GAAP book value and the market price of its shares.

### BRIEF DESCRIPTION OF THE DRAWINGS

In the drawings,

FIG. 1 is flowchart illustrating a method of distributing insurance policy dividends according to a preferred embodiment of the invention; and

FIG. 2 is a flowchart illustrating preferred steps of the method of FIG. 1.

### DESCRIPTION OF PREFERRED EMBODIMENT

The invention disclosed herein is susceptible to embodiment in many different manners. Shown in the drawings and described in detail hereinbelow is a preferred embodiment of the present invention. The present disclosure, however, is an exemplification of the principles and features of the invention, but does not limit the invention to the illustrated embodiment.

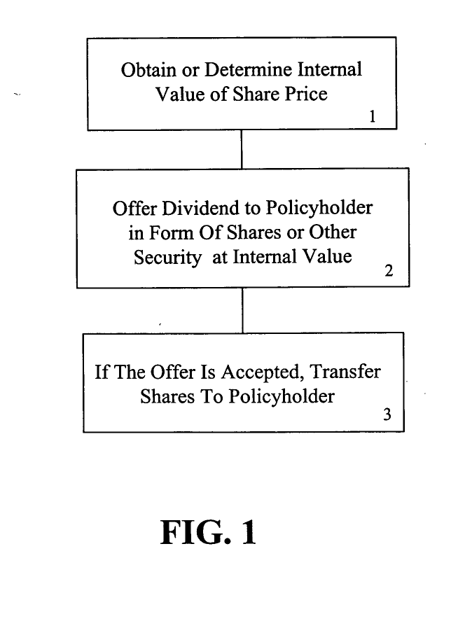

Referring to FIG. 1, an embodiment of the method of the present invention is described. The method comprises determining or obtaining an internal value for a share price or other security of the life insurance company as described in box 1. For example, the internal value may be determined by the life insurance company or obtained from a third part, such as an independent accounting firm or an actuarial consulting firm. Next the insurance company or an agent thereof, offers the dividend in the form of shares or other security to the policyholder at the internal value as shown in box 2. If the policyholder decides to accept the shares or other security at the internal value, the shares or other security are sold or otherwise transferred to the policyholder at the internal value as shown in box 3.

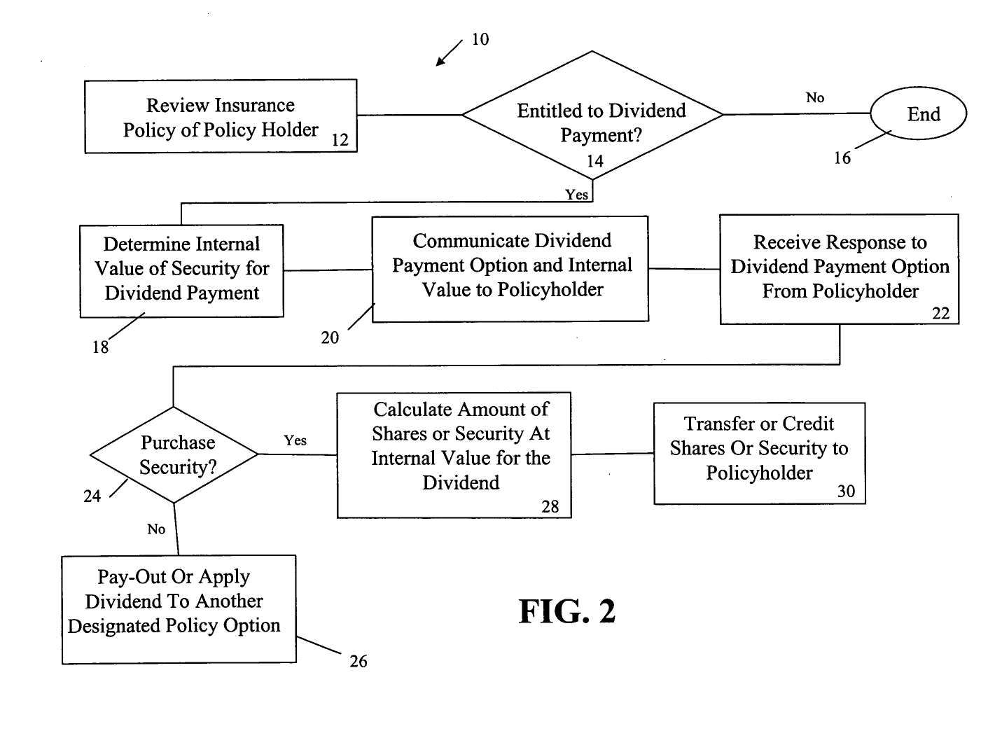

A more detailed explanation of a preferred embodiment of the present invention is discussed with respect to FIG. 2. This preferred method 10 comprises several steps.

The insurance company, upon deciding to issue a dividend, first determines whether a particular policyholder is entitled to a dividend payment 14. This can be done by reviewing the insurance policy of a policyholder 12. Alternatively, the insurance company can utilize a system whereby notification is provided as to which policyholders are entitled to a dividend. If the policyholder is not entitled to a dividend, then the process ends 16 since no dividend will be paid.

If, however, the policyholder is entitled to a dividend, an internal value for company shares or other security is determined or obtained 18. In this embodiment, the internal value is determined based on the GAAP book value. As discussed above, the GAAP book value takes into account the future profit to the insurance company of the volume of life insurance issued and outstanding, assuming an actuarially determined amount of claims which are expected to be paid, policy lapses, such as due to non-payment of the premium, and amortization of commissions payable to the life insurance agents and brokers. The GAAP book value may be obtained from within the insurance company through its own accounting procedures or from a third party or the like, as described above. For example, the GAAP book value may also be obtained from published figures in newspapers or from filings submitted to the SEC and accessed from the SEC Edgar database.

After obtaining the internal value for the share or other security, the payment of a dividend and an option to receive the dividend in the form of company shares or other securities at the internal value is communicated to the policyholder 20. This communication may be accomplished through any method available, such as mail, electronic mail, telephone, etc. Preferably, the communication will include all the necessary information required for the purchase of a company share or other security, such as a mutual fund prospectus or company annual report. For example, the life insurance company can send the policyholder a notice on or about the policy's anniversary date, which sets forth the dollar amount of the dividend, the internal value of the shares (i.e., GAAP book value) and the number of shares obtainable if the policyholder exercises the option by mailing the notice, postmarked prior to the expiration date of the option, to the life insurance company or its transfer agent.

A response to the dividend offer is then received from the policyholder 22. Similar to the offer, the response can be received via any known method, such as mail, electronic mail, or the like. It is also possible for there to be a default procedure in place such that if the policyholder does not respond within a fixed period of time, that the dividend will be paid by check or applied to one of the traditional dividend options, if earlier elected by the policyholder.

It is then determined whether the policyholder wishes to purchase the share or other security 24. If the security is not desired, the dividend money may be paid by check, deposited into account 26, or any of the other dividend options discussed above. If the policyholder's response is to purchase the shares at the internal value, then the number shares that can be purchased at the internal value is calculated 28, and the determined number of shares delivered to the policyholder 30, or to a designee, such as a bank or stock broker, or held by the life insurance company in trust for the policyholder to be delivered upon written instruction, or to one or more designated beneficiaries in the event of the policyholder's death. The calculation of the number of shares may alternatively be determined as part of the notice 20 to the policyholder.

It should be understood that such procedures may be conducted by the insurance company itself, or on its behalf by an agent. For example, the insurance company may utilize a bank, trust company, brokerage firm or transfer agent to create and manage policyholder accounts with publicly tradable shares of the insurance company's stock. This will enable the policyholder to more freely trade the acquired shares. However, to reduce transaction fees, the process may be conducted entirely by the insurance company.

The foregoing description and the drawings are illustrative of the present invention and are not to be taken as limiting. Still other variants within the spirit and scope of the present invention are possible and will be readily apparent to those skilled in the art.

I claim:

1. A method for returning dividends from an insurance policy by an insurance company to a policyholder, the method comprising:
determining an internal share value for shares of the insurance company;
offering the policyholder an option to take the dividends in the form of shares at the internal value; and
transferring the shares to the policyholder at the internal value upon exercise of the option.

2. The method of claim 1, wherein the internal share price is a GAAP book value of the shares.

3. The method of claim 1, further including determining an internal value for the share price periodically prior to a dividend declaration.

4. The method of claim 1, further including receiving instructions from the policyholder as to acceptance of payment in the form of shares at the internal value for the dividends.

5. The method of claim 1, wherein the insurance policy is a life insurance policy.

6. A method for a company to distribute dividends to a policyholder of an insurance policy, the method comprising:
determining an internal value for a security of the company;
offering the dividends in the form of securities of the company to the policyholder; and
transferring rights to the securities of the company to the policyholder at the internal value upon acceptance of offer by the policyholder.

7. The method of claim 6, wherein the security comprises shares of the company and the internal value is a GAAP book value of the shares.

8. The method of claim 6, wherein the insurance policy is a life insurance policy.

9. The method of claim 6, further including periodically setting the internal value for the security.

10. The method of claim 6, further including receiving instructions from the policyholder as to acceptance of payment of the dividend in the form of shares at the internal value.

11. A method for an insurance company to distribute dividends to a policyholder of an insurance policy, the method comprising:
determining whether the policyholder is entitled to a dividend;
determining an internal value of a security of the insurance company;
communicating an option of payment of the dividend in the form of a security to the policyholder at the internal value;
receiving an instruction from the policyholder exercising the option for payment of the dividend as a security at the internal value;
determining an amount of the security for the dividend; and
transferring rights to the amount of the security to the policyholder.

12. The method of claim 11, wherein the security comprises shares of the insurance company and the internal value is a GAAP book value.

13. The method of claim 11, further including periodically setting an internal value for the security.

14. The method of claim 11, wherein the insurance policy is a life insurance policy.
